(19) United States
(12) Patent Application Publication
(10) Pub. No.: US 2014/0062244 A1
(43) Pub. Date: Mar. 6, 2014

(54) ROTOR, ROTARY ELECTRIC MACHINE PROVIDED WITH THIS ROTOR, AND ROTOR MANUFACTURING METHOD

(71) Applicants: Shinya SANO, Toyota-shi (JP); Shinya KATAYAMA, Nishio-shi (JP)

(72) Inventors: Shinya SANO, Toyota-shi (JP); Shinya KATAYAMA, Nishio-shi (JP)

(73) Assignee: TOYOTA JIDOSHA KABUSHIKI KAISHA, Toyota-shi (JP)

(21) Appl. No.: 13/961,207

(22) Filed: Aug. 7, 2013

(30) Foreign Application Priority Data
Aug. 29, 2012 (JP) 2012-188242

(51) Int. Cl. H02K 1/27; H02K 15/03

(52) U.S. Cl. CPC H02K 1/27; H02K 15/03
USPC 310/156.11; 29/596

(57) ABSTRACT

A rotor for a rotary electric machine includes a rotor core, a permanent magnet, and a resin member. The rotor core has a magnet insertion hole. The permanent magnet is arranged in the magnet insertion hole of the rotor core. The resin member has a shape corresponding to a gap between the magnet insertion hole and the permanent magnet. The permanent magnet and the resin member are simultaneously inserted into the magnet insertion hole, and the permanent magnet is fixed in the magnet insertion hole by the resin member.

### INCORPORATION BY REFERENCE

The disclosure of Japanese Patent Application No. 2012-188242 filed on Aug. 29, 2012 including the specification, drawings and abstract is incorporated herein by reference in its entirety.

### BACKGROUND OF THE INVENTION

1. Field of the Invention

The invention relates to a rotor, a rotary electric machine provided with this rotor, and a manufacturing method of a rotor. More particularly, the invention relates to improving a fixing structure and fixing method of a permanent magnet inserted in a magnet insertion hole formed in a rotor core.

2. Description of Related Art

A rotary electric machine that rotates a rotor by electromagnetic action that works between the rotor and a rotating magnetic field generated in a stator is known.

Japanese Patent Application Publication No. 2010-142038 (JP 2010-142038 A) describes a rotor of a rotary electric machine that has a rotor core and a permanent magnet inserted in a magnet insertion hole formed in the rotor core. In this rotor, with the permanent magnet inserted and positioned in the magnet insertion hole, the permanent magnet is fixed to the rotor core by resin being filled in a gap between the magnet insertion hole and the permanent magnet.

With the rotor described in JP 2010-142038 A, the permanent magnet must be inserted and temporarily fixed in the magnet insertion hole before the resin is filled into the magnet insertion hole. In order to facilitate the work of inserting and temporarily fixing the permanent magnet in the magnet insertion hole, a protruding portion is conventionally formed on an inner peripheral surface of the magnet insertion hole. This protruding portion is formed so as to partially abut against an end surface of the permanent magnet. In this way, the protruding portion is formed so that the portion contacting the permanent magnet is small, so resistance when inserting the permanent magnet is inhibited, thus enabling the permanent magnet to be inserted relatively easily. Also, after insertion, the permanent magnet is temporarily fixed by the protruding portion, so the permanent magnet is able to be prevented from coming out of position in the magnet insertion hole by filling in the resin.

As described above, from the viewpoint of facilitating the work of fixing the permanent magnet to the rotor core, the inner peripheral surface of the magnet insertion hole is formed such that the portion that contacts the permanent magnet is relatively small. In other words, the inner peripheral surface of the magnet insertion hole is formed such that there is a relatively large gap between the inner peripheral surface of the magnet insertion hole and the permanent magnet. When a gap is formed between the magnet insertion hole and the permanent magnet in this way, a permeance coefficient of an end portion of the permanent magnet ends up decreasing when the rotary electric machine is in a high load state (i.e., a state in which a large amount of current is supplied to a starter coil). In particular, when a gap is formed between a magnetic pole surface of the permanent magnet and the inner peripheral surface of the magnet insertion hole that faces the magnetic pole surface, the permeance coefficient will decrease even more, so a demagnetization resistance amount of the permanent magnet ends up decreasing significantly, which is problematic.

One possible way to deal with this is to employ a method that involves forming a magnet insertion hole so that no gap is created between the inner peripheral surface of the magnet insertion hole and the end surface of the permanent magnet. However, if there is no gap at all between the inner peripheral surface of the magnet insertion hole and the permanent magnet, it is difficult to insert the permanent magnet into the magnet insertion hole, so workability deteriorates, which is problematic.

### SUMMARY OF THE INVENTION

The invention provides a rotor in which a permanent magnet is able to be easily fixed to a rotor core and that is capable of improving the demagnetization resistance amount of the permanent magnet, as well as to a rotary electric machine provided with this rotor, and manufacturing method of a rotor.

A first aspect of the invention relates to a rotor for a rotary electric machine, that includes a rotor core, a permanent magnet, and a resin member. The rotor core has a magnet insertion hole. The permanent magnet is arranged in the magnet insertion hole of the rotor core. The resin member has a shape corresponding to a gap between the magnet insertion hole and the permanent magnet. The permanent magnet and the resin member are inserted into the magnet insertion hole simultaneously. The permanent magnet is fixed in the magnet insertion hole by the resin member.

Also, the permanent magnet may be integrated with the resin member before being inserted into the magnet insertion hole.

Also, the magnet insertion hole may be formed such that a gap is created on both sides of the permanent magnet in a circumferential direction.

Also, a second aspect of the invention relates to a rotary electric machine that includes the rotor according to the first aspect described above.

Further, a third aspect of the invention relates to a manufacturing method of a rotor for a rotary electric machine, that includes steps i) to iii) described below: i) forming a magnet insertion hole in a rotor core, ii) forming a resin member in a shape corresponding to a gap between the magnet insertion hole and a permanent magnet, and iii) inserting the permanent magnet and the resin member into the magnet insertion hole simultaneously, and fixing the permanent magnet in the magnet insertion hole by the resin member.

According to the rotor, the rotary electric machine provided with this rotor, and the manufacturing method of the rotor according to the invention, the permanent magnet is able to be easily fixed to the rotor core, and the demagnetization resistance amount of the permanent magnet is able to be improved.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a view of the structure of a rotary electric machine according to an example embodiment of the invention;

FIG. 2 is a plan view of a rotor;

FIG. 3 is an enlarged plan view of a portion of the rotor; and

FIG. 4 is a view showing the manner in which a permanent magnet is inserted into a magnet insertion hole.

### DETAILED DESCRIPTION OF EMBODIMENTS

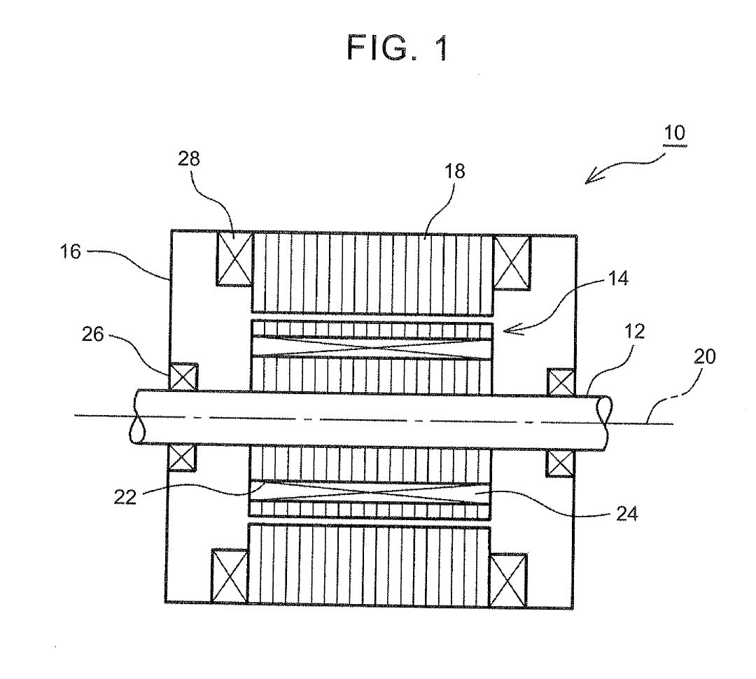

Hereinafter, example embodiments of a rotor and a rotary electric machine provided with this rotor according to the invention will be described with reference to the accompanying drawings. FIG. 1 is a view of the structure of the rotary electric machine according to one example embodiment.

A rotary electric machine 10 is used as a prime mover of a vehicle, for example. The rotary electric machine 10 includes a rotor shaft 12, a rotor 14, a case 16, and a stator 18. The rotor 14 is fixed to the rotor shaft 12. The stator 18 is fixed to the case 16 of the rotary electric machine 10 so as to surround the rotor 14.

The rotor 14 is a cylindrical magnetic body that is concentric with the rotor shaft 12, and is formed by laminated steel sheets that have been laminated together in an axial direction 20, for example. Magnet insertion holes 22 that extend in the axial direction 20 are formed in the laminated steel sheets, and permanent magnets 24 are inserted and arranged in these magnet insertion holes 22. The detailed structure of the rotor 14 will be described later.

The rotor shaft 12 is rotatably supported by a bearing 26 that is provided in the case 16. The rotor shaft 12 in this example embodiment is an output shaft that transmits output from the rotary electric machine 10 to driving wheels, not shown, of the vehicle. This rotor shaft 12 is connected to the driving wheels together via a gear mechanism, not shown.

The stator 18 is arranged around such that there is an air gap around the rotor 14. The stator 18 has magnetic poles, not shown, that protrude on an inner peripheral side of the stator 18 and are arranged a predetermined intervals in the circumferential direction. A coil 28 that is formed by a conducting wire wound around the magnetic poles is arranged in slots that are spaces between the magnetic poles. FIG. 1 shows the coil 28, i.e., coil ends, that extends between slots at both ends of the stator 18. A rotating magnetic field is generated in the stator 18 by energizing this coil 28, and force that is attracted to this rotating magnet field is generated in the rotor 14 having the permanent magnets 24, which causes the rotor 14 to rotate.

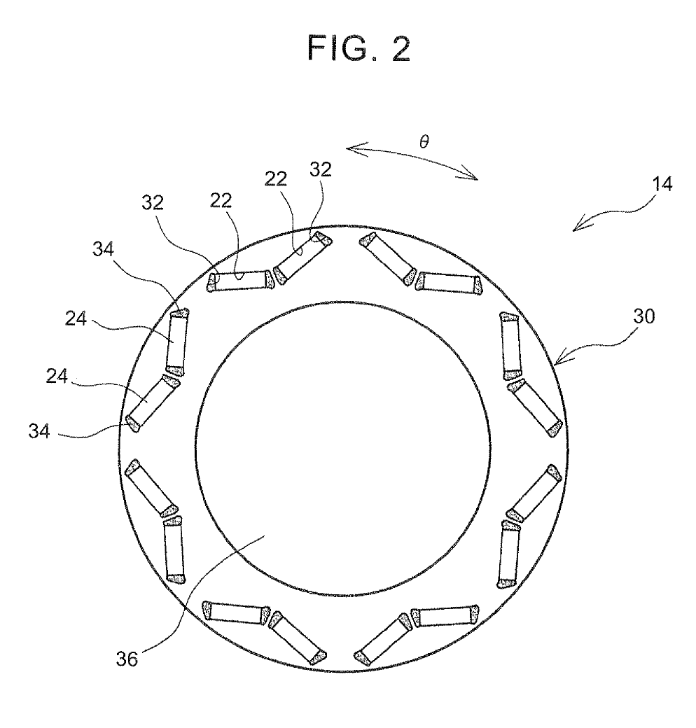

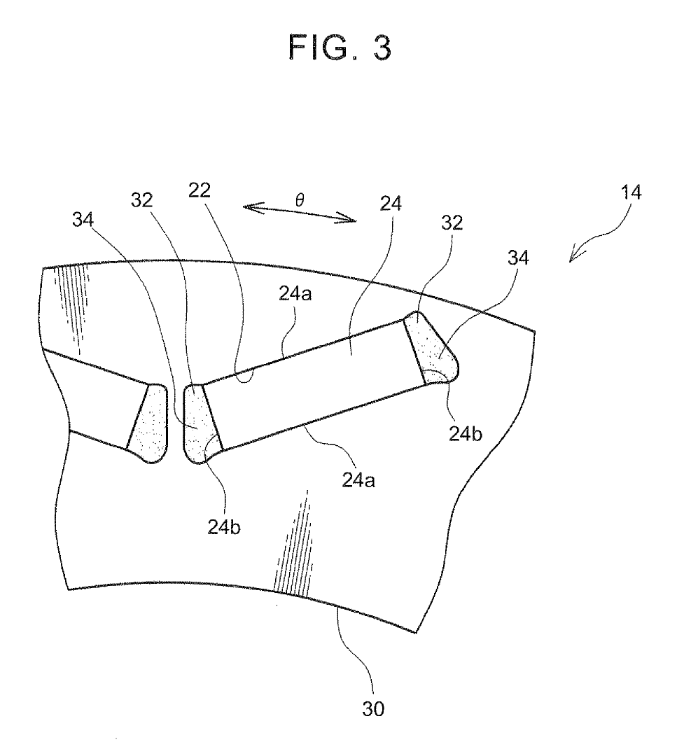

Next, the structure of the rotor 14 will be described with reference to FIGS. 2 and 3. FIG. 2 is a plan view of the rotor 14, and FIG. 3 is an enlarged plan view of a portion of the rotor 14. Arrow θ in the drawings indicates the circumferential direction.

The rotor 14 according to this example embodiment of the invention includes a rotor core 30, the permanent magnets 24, and resin members 34. Whenever possible, the permanent magnets 24, the resin members 34, and other such elements will be described in the singular to simplify the description. The permanent magnet 24 is inserted into a magnet insertion hole 22 formed in the rotor core 30. The resin member 34 is formed in a shape corresponding to a gap 32 between the magnet insertion hole 22 and the permanent magnet 24. In the rotor 14 structured in this way, the permanent magnet 24 is able to be fixed in the magnet insertion hole 22 by the resin member 34, by inserting the permanent magnet 24 and the resin member 34 into the magnet insertion hole 22 simultaneously. That is, the permanent magnet 24 is able to be positioned in the magnet insertion hole 22 by the resin member 34 that is simultaneously inserted with the permanent magnet 24.

This kind of fixing structure in which the permanent magnet 24 is fixed by the resin member 34 makes it possible to eliminate the fixing structure used conventionally, i.e., a protruding portion formed so as to abut against the permanent magnet to prevent misalignment, on an inner peripheral surface of the magnet insertion hole. Eliminating this protruding portion makes it possible to eliminate a gap that ends up being formed around the protruding portion, so a decrease in the permeance coefficient of the permanent magnet that is caused by this gap can be prevented, which in turn enables the demagnetization resistance amount of the permanent magnet to be improved.

As shown in FIG. 2, the rotor 14 includes the rotor core 30, and the permanent magnet 24 and the resin member 34 that are arranged in the magnet insertion hole 22 formed in the rotor core 30.

The rotor core 30 is formed by magnetic steel sheets laminated together in the axial direction 20 (shown in FIG. 1). The rotor core 30 is formed in an annular shape. A through-hole 36 through which the rotor shaft 12 is inserted is formed in the center portion of the rotor core 30.

Sixteen of the magnet insertion holes 22, for example, are formed at intervals in a circumferential direction θ in the rotor core 30. The permanent magnet 24 and the resin member 34 are both inserted into each magnet insertion hole 22. The resin member 34 is an insulating resin, such as epoxy resin, for example.

In this example embodiment, adjacent magnet insertion holes 22 are arranged such that the distance between them in the circumferential direction θ becomes larger farther toward the radially outer side. That is, adjacent magnet insertion holes 22 are arranged in a generally V-shape as shown in FIG. 2. One magnetic pole is fowled by the permanent magnet 24 inserted in each of the magnet insertion holes 22 that are arranged in a general V-shape. That is, the polarity of a magnetic pole face 24a on a radially outer side of one permanent magnet 24 matches the polarity of the magnetic pole face 24a on the radially outer side of another permanent magnet 24. Similarly, the polarity of a magnetic pole face 24a on a radially inner side of one permanent magnet 24 matches the polarity of the magnetic pole face 24a on the radially inner side of another permanent magnet 24.

The magnet insertion hole 22 is formed such that a gap 32 is created on each side of the permanent magnet 24 in the circumferential direction θ. As shown in FIG. 3, the gap 32 is a region surrounded by an end surface 24b of the permanent magnet 24 in the circumferential direction θ, and the inner peripheral surface of the magnet insertion hole 22, and is formed in a basic and simple shape. The resin member 34 that has a shape corresponding to the gap 32 is able to be easily formed by making the shape of the gap 32 basic and simple in this way. Also, by inserting this resin member 34 into the magnet insertion hole 22 simultaneously with the permanent magnet 24, the permanent magnet 24 is supported by the resin members 34 from the outside at both ends in the circumferential direction θ, and is thus fixed in the magnet insertion hole 22.

Meanwhile, the inner peripheral surface of the magnet insertion hole 22 that faces the magnetic pole face 24a on both sides of the permanent magnet 24 is formed such that there is a small gap that is just large enough to allow the permanent magnet 24 to slide, between the inner peripheral surface of the magnet insertion hole 22 and each magnetic pole face 24a. Eliminating to the greatest extent possible a magnetic air gap in the radial direction enables a decrease in the permeance coefficient of the magnetic pole face 24a to be prevented, and thus enables the demagnetization resistance amount of the permanent magnet 24 to be improved.

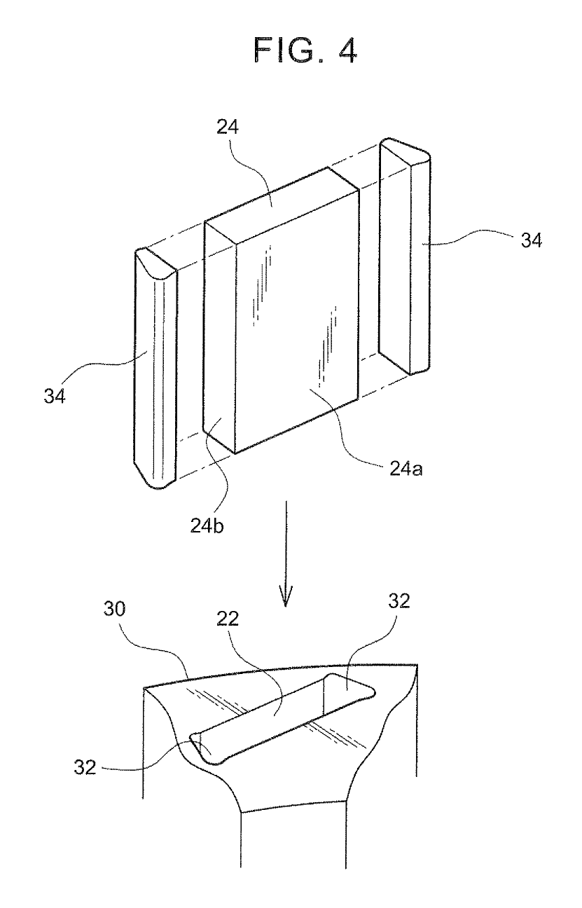

Next, the procedure for inserting the permanent magnet 24 into the magnet insertion hole 22 will be described with reference to FIG. 4. FIG. 4 is a view illustrating the manner in which the permanent magnet 24 is inserted into the magnet insertion hole 22.

First, the resin member 34 is formed beforehand to match the shape of the gap 32. Then the permanent magnet 24 and the resin member 34 are inserted into the magnet insertion hole 22 simultaneously. As a result, the permanent magnet 24 is fixed in the magnet insertion hole 22. That is, the permanent magnet 24 is fixed to the rotor core 30.

In this example embodiment, a case in which the permanent magnet 24 and the resin member 34 are inserted into the magnet insertion hole 22 simultaneously is described, but the invention is not limited to this structure. The permanent magnet 24 and the resin member 34 may also be integrated together beforehand and then inserted into the magnet insertion hole 22.

What is claimed is:

1. A rotor for a rotary electric machine, comprising:
a rotor core having a magnet insertion hole;
a permanent magnet arranged in the magnet insertion hole of the rotor core; and
a resin member having a shape corresponding to a gap between the magnet insertion hole and the permanent magnet, the resin member and the permanent magnet being inserted into the magnet insertion hole simultaneously, the permanent magnet being fixed in the magnet insertion hole by the resin member.

2. The rotor according to claim 1, wherein the permanent magnet is integrated with the resin member before being inserted into the magnet insertion hole.

3. The rotor according to claim 1, wherein the magnet insertion hole is formed such that a gap is created on both sides of the permanent magnet in a circumferential direction.

4. A rotary electric machine comprising:
a rotor shaft;
the rotor according to claim 1, the rotor being fixed to the rotor shaft;
a case; and
a stator fixed to the case so as to surround the rotor.

5. A manufacturing method of a rotor for a rotary electric machine, comprising:
forming a magnet insertion hole in a rotor core;
forming a resin member in a shape corresponding to a gap between the magnet insertion hole and a permanent magnet; and
inserting the permanent magnet and the resin member into the magnet insertion hole simultaneously, and fixing the permanent magnet in the magnet insertion hole by the resin member.

6. The manufacturing method of the rotor according to claim 5, wherein the permanent magnet is integrated with the resin member before being inserted into the magnet insertion hole.
